(19) United States
(12) Patent Application Publication
(10) Pub. No.: US 2003/0158754 A1
(43) Pub. Date: Aug. 21, 2003

(54) WEB-BASED METHOD AND SYSTEM FOR MAINTAINING AND ACCESSING MEDICAL RECORDS

(75) Inventor: BARRY M. ELKIND, SHORT HILLS, NJ (US)

Correspondence Address: ARTHUR I NAVARRO, NAVARRO IP LAW GROUP, 801 E CAMPBELL ROAD SUITE 655, RICHARDSON, TX, 75081

(73) Assignee: Arthur Navarro

(21) Appl. No.: 09/444,006

(22) Filed: Nov. 19, 1999

(51) Int. Cl. G06F 17/60

(52) U.S. Cl. 705/3

(57) ABSTRACT

The medical records system includes a medical records database used to store medical record information for a patient. The system provides a graphical user interface from which the patient can enter, update and store their medical records information. The graphical user interface can be part of a client terminal at a local network site. A computer network, such as the Internet, or other wide area network configuration, can be used to implement the medical records system. In particular, the medical records database can be accessed by the client terminal from any location via the computer network providing a mechanism for accessing patient medical records information from any location. In this way, the medical history of the patient is maintained constant, up-to-date and made available for future access both by the patient and the physician.

### BACKGROUND OF THE INVENTION

1. Technical Field of the Invention

The present invention relates to methods and systems for electronically retrieving specified items from a database. In particular, the present invention relates to techniques for accessing medical records electronically maintained in a medical records database. More particularly, the present invention relates to techniques for displaying and accessing medical records via a web-based computer network and to provide individualized health related notifications and alerts.

2. Description of the Related Art

In our modern and highly mobile society, physicians and patients are increasingly faced with the problems of rapidly and efficiently obtaining accurate and current medical records. For a variety of reasons, patients find themselves moving from one city to another, fragmenting their medical care. Each time a patient selects a new physician, the patient is often required to recall his or her entire medical history, which is entered into a new medical record by the physician or physician's assistant. This is a time consuming process.

A new physician can attempt to contact a previous physician requesting transfer of past medical records, but this is often a highly inefficient and slow process, particularly subject to time-consuming bureaucratic procedures. More often than not, physicians rely on building a new medical history file for their patients. This process is particularly dangerous because individuals often can forget important medical information, such as medication allergies, vaccination records, and so forth. It is critical for a physician, particularly those facing emergency and life threatening situations, to have an accurate and up to date medical record rapidly.

Presently, medical records are compiled and stored primarily in handwritten files or on restricted computer networks or storage facilities that can only be accessed by a few select individuals. In an emergency situation, where time is critical in diagnosing a patient's condition, many minutes can go by as the patient attempts to recall his or her past medical history. Depending on how complex this past medical history is, critical time can be lost which could have been saved had the physician been able to access the patient's record immediately. Sometimes the patient cannot provide any medical history whatsoever, especially where the patient is ill or injured.

In the past, attempts have been made to provide physicians, particularly emergency room physicians, with quick and accurate medical information. One attempt involves the use of encrypted cards which contain a patient's medical history. However, such cards can be easily misplaced or lost by a patient. When the patient shows up at the physician's office without such a card, the patient must attempt to recall all important medical information. Another attempt at providing physicians with patient medical history includes the use of metal tags which can be worn on a necklace about the patient's neck. This technique is limited because only a limited amount of important medical information can be engraved on the metal tag. The oldest technique involves simply calling the patient's previous physician. However, as indicated previously, this is a time consuming process, particularly subject to bureaucratic “red tape.”

Based on the foregoing, it can be appreciated that what is needed is a way to overcome these problems with a fast and efficient method and system for allowing patients to create and maintain their medical records. In addition, a method and system that permits a patient and physician to have immediate access to his or her medical records in any city at any time would also be desirable. It is believed the present invention described herein addresses and solves these aforementioned problems.

### SUMMARY OF THE INVENTION

It is therefore one object of the present invention to provide an improved method and system for patients to enter, store and retrieve specified medical records information.

It is another object of the present invention to provide a method and system for accessing medical records electronically maintained in a medical record database.

It is still another object of the present invention to provide an improved method for displaying and accessing medical records via a web-based computer network.

The above and other objects are achieved as is now described. A method and system in a computer network for rendering medical records using a graphical user interface at a local network site. The medical records system of the present invention includes a medical records database used to store medical record information for a patient. The system provides a graphical user interface from which the patient can enter, update and store their medical records information. The graphical user interface can be part of a client terminal at a local network site. A computer network, such as the Internet, or other wide area network configuration, can be used to implement the medical records system. In particular, the medical records database can be accessed by the client terminal from any location via the computer network providing a mechanism for accessing patient medical records information from any location. In this way, the medical history of the patient is maintained constant, up-to-date and made available for future access both by the patient and the physician. Security measures, such as passwords, patient IDs and other similar measures can be employed to provide secured access to the medical records information in the medical records database over the computer network.

In one embodiment, a tracking mechanism can be utilized to provide automatic notifications and updates to patients relative to specified medicines, drugs and medical products of interest to patients. The tracking mechanism can include a set of tracking directories which, at the option of the patient, can be used to provide medical alerts and notifications. The tracking mechanism can be maintained at a remote network site within the computer network separate from the medical records database. In this way, the patient can select the option of receiving alerts and notices since registration with the tracking directories is discretionary with the patient.

Particular medical records can be retrieved from a remote network site, in response to patient input. The retrieved particular medical records are then graphically displayed in a graphical user interface at the local network site, in response to retrieving the particular medical records from the remote network site, thereby enabling a patient to interactively enter, access, review and update medical records from the local network site.

### BRIEF DESCRIPTION OF THE DRAWINGS

The novel features believed characteristic of this invention are set forth in the appended claims. The invention itself, however, as well as a preferred mode of use, further objects, and advantages thereof, will best be understood by reference to the following detailed description of an illustrative embodiment when read in conjunction with the accompanying drawings, wherein:

FIG. 1 illustrates a pictorial representation of a computer system, which may be utilized to implement a preferred embodiment of the present invention;

FIG. 2 depicts a representative hardware environment of the computer system of a preferred embodiment of the present invention;

FIG. 3 illustrates a block diagram illustrative of a client/server architecture, in accordance with a preferred embodiment of the present invention;

FIG. 4 depicts a detailed block diagram of a client/server architecture in accordance with a preferred embodiment of the present invention;

FIG. 5 illustrates a block diagram of a computer network in which a preferred embodiment of the present invention can be implemented;

FIG. 6 depicts a block diagram of a high-level web-based medical records information system, in accordance with a preferred embodiment of the present invention;

FIG. 7 illustrates an example graphical user interface window displaying portions of a high-level web-based medical records information system, in accordance with a preferred embodiment of the present invention;

FIG. 8 depicts a high-level flow diagram of operations illustrating method steps for carrying out the present invention;

FIG. 9 illustrates a high-level flow diagram of operations illustrating method steps for creating an electronic web-based medical record, in accordance with a preferred embodiment of the present invention;

FIG. 10 depicts additional method steps associated with the high-level flow diagram of operations illustrated in FIG. 9, in accordance with a preferred embodiment of the present invention;

FIG. 11 illustrates additional method steps associated with the high-level flow diagram of operations depicted in FIG. 9, in accordance with a preferred embodiment of the present invention; and

FIG. 12 depicts additional method steps associated with the high-level flow diagram of operations illustrated in FIG. 9, in accordance with a preferred embodiment of the present invention.

### DETAILED DESCRIPTION OF THE PREFERRED EMBODIMENTS

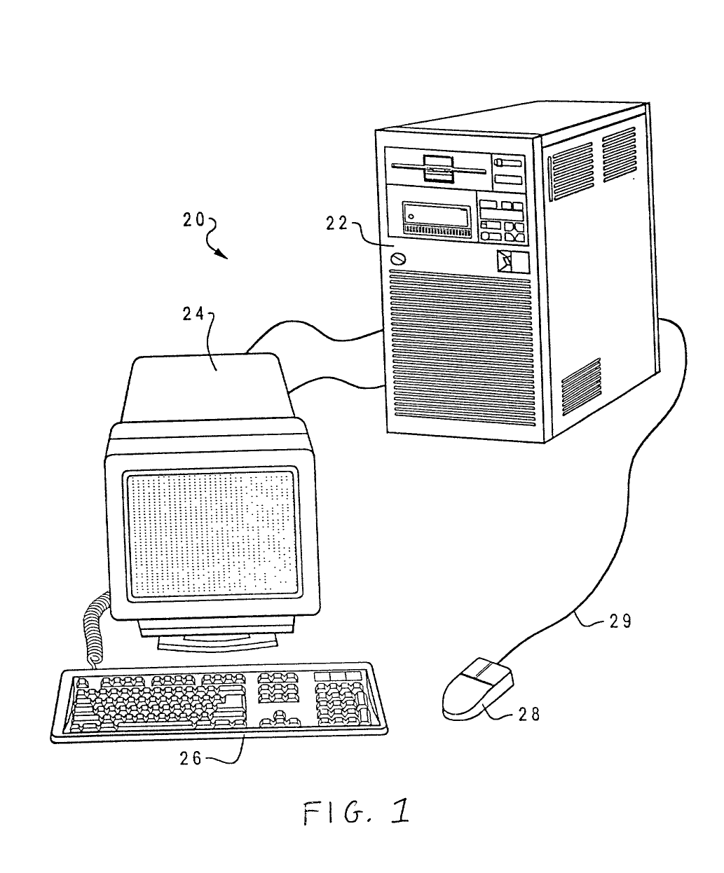

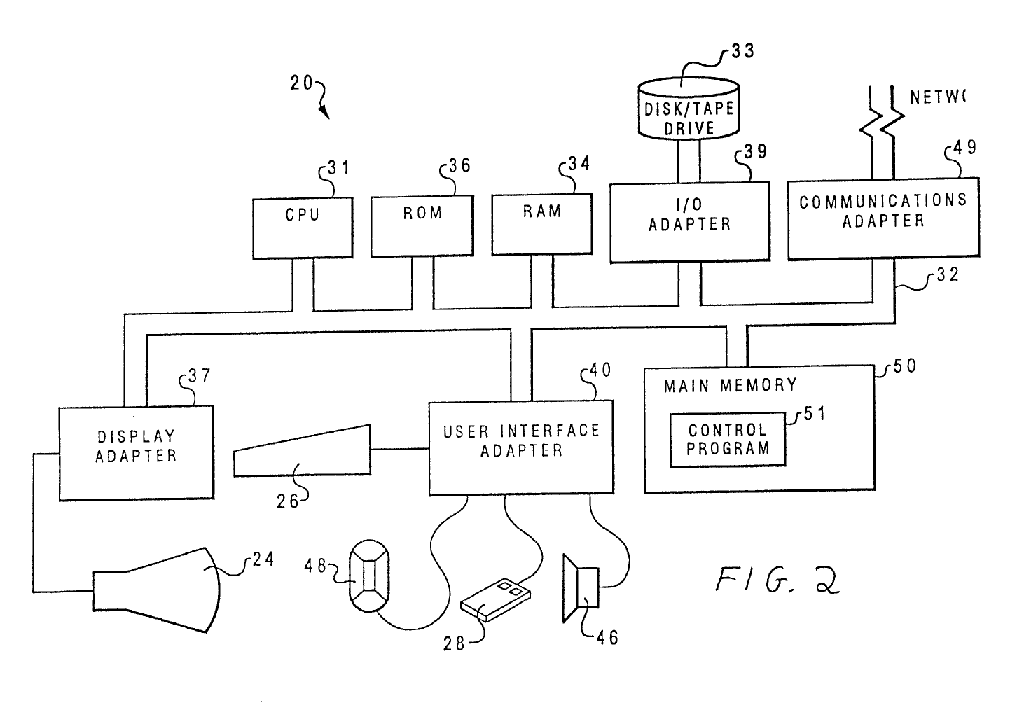

With reference now to the figures and in particular with reference to FIG. 1, therein is depicted a pictorial representation of a computer system 20 in accordance with a preferred embodiment of the present invention. The computer system 20 is shown to include a system unit 22, a video display terminal 24, a keyboard 26, and a mouse 28. Those skilled in the art will appreciate that the method and system of the present invention apply equally to any computer system, regardless of whether the computer system is a complicated multi-patient computing apparatus or a single-patient workstation. In FIG. 1 and FIG. 2, like parts are identified by like numbers.

FIG. 2 depicts a representative hardware environment of the computer system of a preferred embodiment of the present invention. Computer system 20 includes a Central Processing Unit (“CPU”) 31, such as a conventional microprocessor, and a number of other units interconnected via system bus 32. Such components and units of computer system 20 can be implemented in a system unit such as system unit 22 of FIG. 1. Computer system 20 further includes random-access memory (“RAM”) 34, read-only memory (“ROM”) 36, display adapter 37 for connecting system bus 32 to video display terminal 24, and I/O adapter 39 for connecting peripheral devices (e.g., disk and tape drives 33) to system bus 32.

Video display terminal 24 is the visual output of computer system 20. Video display terminal 24 can be a CRT-based video display well known in the art of computer hardware. However, with a portable or notebook-based computer, video display terminal 24 can be replaced with an LCD-based or a gas plasma-based flat-panel display. Computer system 20 further includes patient interface adapter 40 for connecting keyboard 26, mouse 28, speaker 46, microphone 48, and/or other patient interface devices, such as a touch-screen device (not shown), to system bus 32. Communications adapter 49 connects computer system 20 to a computer network. Although computer system 20 is shown to contain only a single CPU and a single system bus, it should be understood that the present invention applies equally to computer systems that have multiple CPUs and to computer systems that have multiple buses that each perform different functions in different ways.

Computer system 20 also includes an interface that resides within a machine-readable media to direct the operation of computer system 20. Any suitable machine-readable media may retain the interface, such as RAM 34, ROM 36, a magnetic diskette, magnetic tape, or optical disk (the last three being located in disk and tape drives 33). Any suitable operating system and associated interface (e.g., Microsoft Windows) may direct CPU 31. Other technologies also can be utilized in conjunction with CPU 31, such as touch-screen technology or human voice control. Those skilled in the art will appreciate that the hardware depicted in FIG. 2 may vary for specific applications. For example, other peripheral devices such as optical disk media, audio adapters, or chip programming devices, such as PAL or EPROM programming devices well-known in the art of computer hardware and the like, may be utilized in addition to or in place of the hardware already depicted.

Main memory 50 is connected to system bus 32, and includes a control program 51. Control program 51 resides within main memory 50, and contains instructions that, when executed on CPU 31, carries out the operations depicted in the logic flow diagrams of FIG. 6 to FIG. 9 described herein. The computer program product also can be referred to as a program product.

It is important to note that, while the present invention has been (and will continue to be) described in the context of a fully functional computer system, those skilled in the art will appreciate that the present invention is capable of being distributed as a program product in a variety of forms, and that the present invention applies equally regardless of the particular type of signal-bearing media utilized to actually carry out the distribution. Examples of signal-bearing media include: recordable-type media, such as floppy disks, hard disk drives, and CD ROMs, and transmission-type media such as digital and analog communication links.

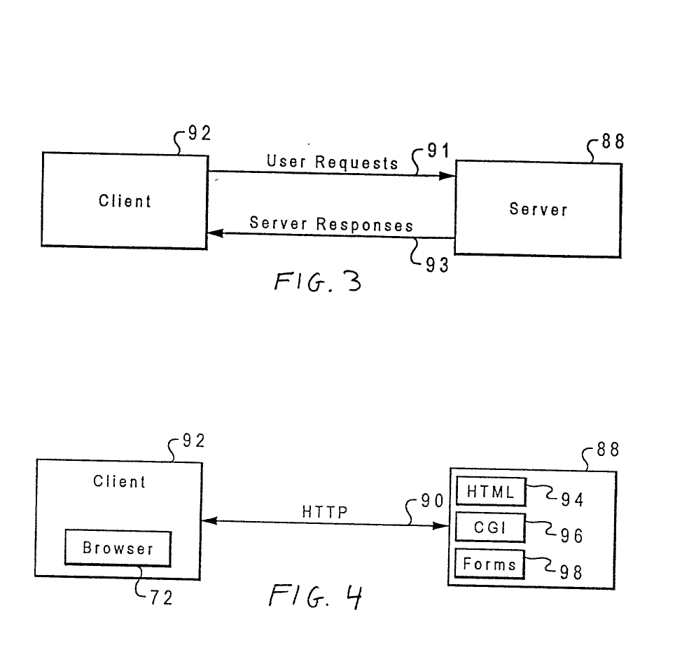

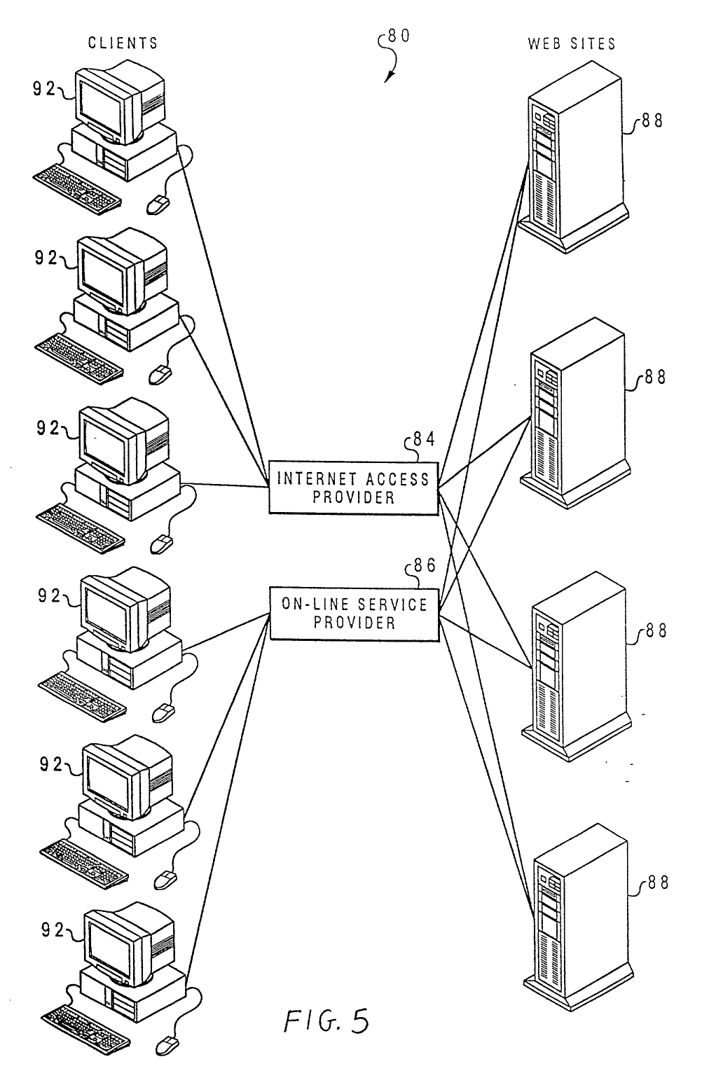

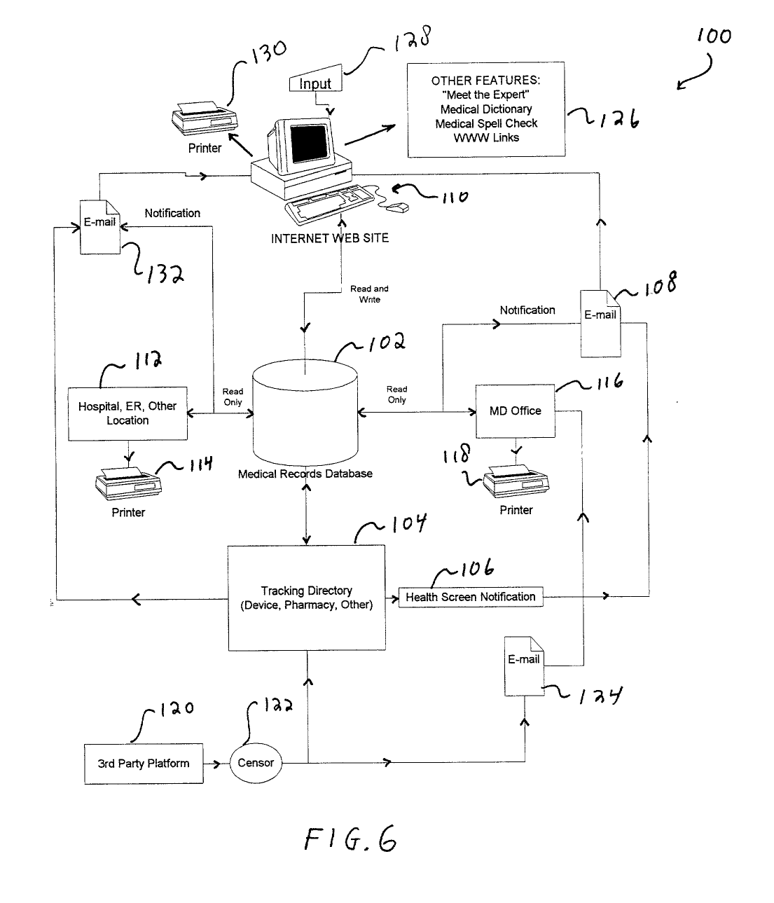

In FIG. 3, FIG. 4, and FIG. 5, like parts are indicated by like numbers. FIG. 3 illustrates a block diagram illustrative of a client/server architecture in accordance with a preferred embodiment of the present invention. In FIG. 3, patient requests 91 for news are sent by a client application program 92 to a server 88. Server 88 can be a remote computer system accessible over the Internet or other communication networks. Client application program 92 may be utilized in association with computer system 20 of FIG. 1 and the implementation of computer system 20, as illustrated in FIG. 2.

Server 88 performs scanning and searching of raw (e.g., unprocessed) information sources (e.g., newswire feeds or newsgroups) and, based upon these patient requests, presents the filtered electronic information as server responses 93 to the client process. The client process may be active in a first computer system, and the server process may be active in a second computer system, communicating with one another over a communications medium, thus providing distributed functionality and allowing multiple clients to take advantage of the information-gathering capabilities of the server.

FIG. 4 illustrates a detailed block diagram of a client/server architecture in accordance with a preferred embodiment of the present invention. Although the client and server are processes that are operative within two computer systems, these processes being generated from a high-level programming language (e.g., PERL), which is interpreted and executed in a computer system at runtime (e.g., a workstation), it can be appreciated by one skilled in the art that they may be implemented in a variety of hardware devices, either programmed or dedicated.

Client 92 and server 88 communicate by utilizing the functionality provided by HTTP. Active within client 92 is a first process, browser 72, which establishes connections with server 88, and presents information to the patient. Any number of commercially or publicly available browsers can be utilized in various implementations in accordance with the preferred embodiment of the present invention. For example, the Mosaic-brand browser available from the National Center for Supercomputing Applications (NCSA) in Urbana-Champaign, Illinois, can be utilized in accordance with a preferred embodiment of the present invention. Other browsers, such as Netscape®, also provide the functionality specified under HTTP. “Netscape” is a trademark of Netscape, Inc.

Server 88 executes the corresponding server software, which presents information to the client in the form of HTTP responses 90. The HTTP responses 90 correspond with the Web pages represented using HTML, or other data generated by server 88. Server 88 provides HTML 94. Under certain browsers, such as the Mosaic-brand browser described herein, a Common Gateway Interface (CGI) 96 is also provided, which allows the client program to direct server 88 to commence execution of a specified program contained within server 88. This may include a search engine that scans received information in the server for presentation to the patient controlling the client.

By utilizing this interface, and HTTP responses 90, server 88 may notify the client of the results of that execution upon completion. Common Gateway Interface (CGI) 96 is one form of a gateway, a device utilized to connect dissimilar networks (i.e., networks utilizing different communications protocols) so that electronic information can be passed from one network to the other. Gateways transfer electronic information, converting such information to a form compatible with the protocols used by the second network for transport and delivery.

In order to control the parameters of the execution of this server-resident process, the client may direct the filling out of certain “forms” from the browser. This is provided by the “fill-in-forms” functionality (i.e., forms 98), that is provided by some browsers, such as the Mosaic-brand browser described herein. This functionality allows the patient via a client application program to specify terms in which the server causes an application program to function (e.g., terms or keywords contained in the types of stories/articles, which are of interest to the patient). This functionality is an integral part of the search engine.

FIG. 5 is a diagram illustrative of a computer network 80, which can be implemented in accordance with a preferred embodiment of the present invention. Computer network 80 is representative of a wide area network such as the Internet, which can be described as a known computer network based on the client-server model discussed herein. Conceptually, the Internet includes a large network of servers 88 that are accessible by clients 92, typically patients of personal computers, through some private Internet access provider 84 (e.g., such as Internet America) or an on-line service provider 86 (e.g., such as America On-Line, Prodigy, Comppatientve, and the like). Each of the clients 92 may run a browser to access servers 88 via the access providers. Each server 88 operates a so-called “Web site” that supports files in the form of documents and pages. A network path to servers 88 is identified by a Universal Resource Locator (URL) having a known syntax for defining a network collection. Computer network 80 can thus be considered a “web-based” computer network.

Having described the hardware, software and networking systems in which the present invention can be implemented, a discussion of the medical records information system according to the invention follows. As such, reference is made to FIG. 6 which depicts a block diagram of a high-level web-based medical records information system 100, in accordance with one embodiment of the present invention. System 100 includes a medical records database 102, which may be electronically stored at a remote network site within a computer network, such as computer network 80 of FIG. 5. The remote network site is configured as a server within computer network 80, and operates in the context of a client/server network, such as computer network 80 of FIG. 5.

A local network site, operating as a client within a computer network, such as computer network 80, is depicted as client 110. An Internet web site may be graphically displayed at client 110. Those skilled in the art will appreciate that client 110 may be implemented within the context of a computer, such as computer system 20 of FIG. 1. Medical records database 102 can be stored at a server, such as server 88 of FIGS. 3 to 5.

Because the medical records database 102 is electronically maintained at a remote network site within a computer network, such as computer network 80, tracking mechanism 104 may also be maintained at the same remote network site. However, those skilled in the art will appreciate that tracking mechanism 104 may also be stored at other remote network sites (i.e. servers) within a web-based computer network. Tracking mechanism 104 includes a set of tracking directories which provide the mechanism for permitting a patient to receives notices and updates related, for example, to medicines, drugs, and pharmaceutical devices or products. A patient can register with specified tracking directories corresponding to such medicines, drugs, and/or pharmaceutical devices and information about such medicines, drugs, and/or pharmaceutical devices can be delivered to registered patients in the form of electronics notices or alerts over the computer network 80. In this manner, data relating to medical devices, such as pacemakers or other implants, for example, can be distributed to patients indicated within the tracking directories of the tracking mechanism 104. It should be understood, however, that the tracking mechanism 104 is not permitted to alter the medical records contained in the medical records database 102.

System 100 is configured so that a patient located at a hospital, emergency room, or other medical location, as depicted at block 112, may retrieve information from medical records database 102 in a secure fashion. Such retrieval can be performed on a “read only” basis so that the information in the system 100 is maintained in tact. This also provides security of the data contained within the medical records database 102 since it should only be modified by the patient of the system 100 with a password, patient identifier or other similar means of maintaining security over the Internet. Thus, a patient or physician at a hospital, emergency room, or other medical location, having access to a web-based computer network, may access information contained in medical records database 102 via a local network site (e.g., a client). When such access is achieved, a notification can be sent to the patient user of the system 100 through an e-mail 108 as shown. In this way, the patient user of the system is informed that access to his or her medical records information has been made.

Without the necessary password, patient ID or security clearance, the patient or physician may not alter the information contained in medical records database 102. The patient or physician may print out desired medical records retrieved from medical records database 102 via printer 114. An emergency room physician, with access to system 100, can thus print out a patient's entire medical history on a standard form utilizing printer 114, thereby saving time and energy and possibly the patient's life if forced to manually track down the patient's medical history.

System 100 is also configured so that a patient located a doctor's office, as depicted at block 116, may also retrieve information from medical records database 102. Again, such retrieval is of a “read only” nature, so that a patient located at the doctor's office, who has access to a web-based computer network, may retrieve information from medical records database 102 via a local network site. Again, the patient may not alter any information retrieved from or contained in medical records database 102 without the proper password or patient identifier. A patient located at the doctor's office, as illustrated at block 116, may print via printer 118, desired medical records retrieved from medical records database 102. A patient's entire medical history can thus be printed on a standard form directly at the physician's office, thereby preventing the physician from having to contact the patient's previous physician for important medical information.

An interactive web site displayed at client 110 permits a patient to create, alter and update his or her medical records. These medical records, once created, are electronically stored in the medical records database 102. Note that the link between medical records database 102 and client 110 is a read/write link. As indicated at block 128, data may be input at client 110 and transferred via a client/server computer network to medical records database 102, which may be located at a server or other remote network site within a web-based computer network.

Client 110 communicates with the server or remote network site at which the medical records database 102 is located utilizing the functionality provided by HTTP. Active within client 110 is a first process (i.e., a browser) which establishes connections with the server or remote network site at which medical records database 102 resides. The browser thus presents information to the patient. As indicated previously, any number of commercially or publicly available browsers can be utilized in various implementations in accordance with the preferred embodiment of the present invention. For example, Netscape™ provides the functionality specified under HTTP.

The server or remote network site at which medical records database 102 is located executes corresponding server software, and presents information to client 110 in the form of HTTP responses. These HTTP responses correspond to Web pages represented using HTML, or other data generated by the server or remote network site at which medical records database 102 is located. An interactive medical records web page is thus displayed at client 110. As indicated at block 126, a variety of other features may be incorporated into this web page, include a feature which presents “expert” medical information to the patient (i.e., “meet the expert), a medical dictionary, a medical spell checker, and various hypertext World Wide Web medical links. Personal medical records transferred from medical records database 102 may be printed utilizing printer 130, which is attached to client 110.

In one embodiment, the tracking mechanism 104 includes a health screen notification feature, as indicated at block 106. The tracking mechanism 104 can be used to deliver medical anniversary notices corresponding to time periods when the patient should obtain a checkup or follow-up examination, for example. In response, to identifying important medical anniversary data, a health screen notification, which contains medical anniversary data, is transmitted, via an e-mail notice 108 to a patient utilizing client 110. Those skilled in the art will of course appreciate that e-mail notifications can be accessed only by an authorized patient of an authorized e-mail Internet address.

An example of medical anniversary notices feature of the tracking mechanism 104 could apply to the use of system 100 to transmit colonoscopy notices. The American Medical Association recommends that all individuals over the age of fifty submit to a colonoscopy test once every two years. Thus, if a patient has registered with the tracking directory corresponding to colonoscopy, the tracking mechanism 104 could automatically format and send a notice or alert to the patient, in the form of an e-mail notice, over the Internet. The health screen notices includes a statement requesting the patient to consult with a physician soon regarding the need for submitting to a colonoscopy screening. Similar notices can be provided to the patient for a variety of medical screening tests.

System 100 additionally includes a third party platform 120 which permits third parties such as pharmaceutical and medical device companies, for example, to communicate with patients of system 100 (i.e., patients). Periodically, notifications may be transmitted from third party platform 120, thereby enabling pharmaceutical is and medical device manufacturers to properly provide specific patients with current pharmaceutical and medical device information via system 100.

A censor 122 linked to third party platform 120 may be configured to prevent third party pharmaceutical and medical device companies from “spamming” patients with unwanted advertisements and sales information via an e-mail notice, such as e-mail notice 124. E-mail notice 124 may then be transmitted to a physician located at a doctor's office, as indicated at block 116, who may then contact the patient directly with current pharmaceutical and medical device information provided by third party manufacturers or drug companies.

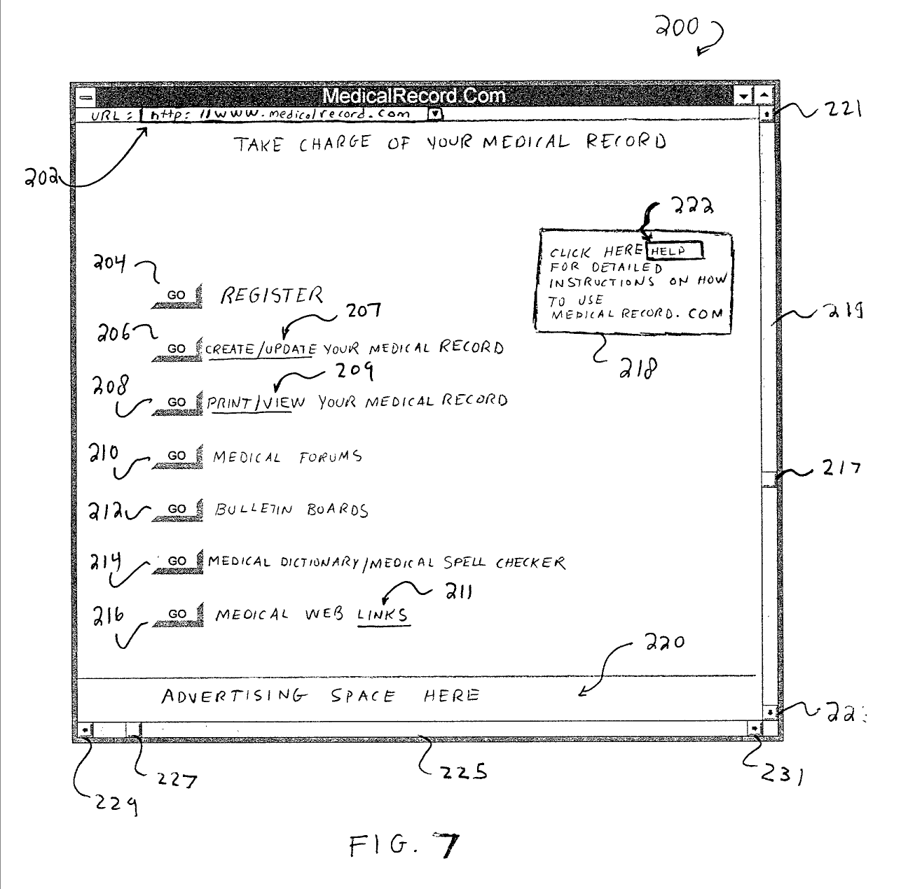

It is contemplated, that patients of the medical records system 100 would utilize a web browser program or other similar application to obtain access to an Internet accessible application contained at a remote site, with the underlying functionality of the site provided to patients via a graphical user interface or other similar vehicle as is understood by those of ordinary skill in the art. FIG. 7 illustrates an example graphical user interface window 200 displaying portions of a high-level web-based medical records information system, in accordance with one embodiment of the present invention.

Within graphical user interface window 200, a “web page” is displayed, referred to by the example Internet address “http://www.medicalrecords.com” indicated at 202. The “web page” (also referred to by some designers simply as a “page”) displayed within graphical user interface window 200 is a data file written in a hyper-text markup language (HTML) that may have text, graphic images, and even multimedia objects such as sound recordings or moving video clips associated with that data file. The web page is displayed as a viewable object at a local network site, such as client 110 of FIG. 6. A viewable object contains one or more components, such as spreadsheets, text, hotlinks, pictures, sound, and video objects. The web page can be constructed by loading one or more separate files into an active directory or file structure that is then displayed as a viewable object within a graphical user interface.

Graphical user interface window 200 thus displays a portion of a viewable object (i.e., a hypertext document) constructed using HTML. The size and position of elevator 217 within vertical scroll bar 219 corresponds to the size and position of the current viewable page in relation to hypertext document displayed within graphical user interface window 200. In the example of FIG. 7, because the hypertext document displayed within graphical user interface window 200 includes too many pages to view simultaneously, the patient can position a mouse cursor over up-arrow section 221 or down-arrow section 223 of vertical scroll bar 219 and click a pointing device (e.g., a mouse) to scroll the hypertext document upward or downward, as appropriate. A horizontal scroll bar 225 includes arrow sections 229 and arrow sections 231 for scrolling the hypertext document displayed within graphical user interface window 200 respectively left or right. Elevator 227, which is analogous to elevator 217, also permits a patient to scroll right or left. Graphical user interface window 200 thus displays a web page at a remote network site within a web-based computer network that enables a patient to choose commands, start programs, and see lists of files and other options by pointing to pictorial representations (i.e., icons) and lists of menu items on the screen. Choices can generally be activated either with a keyboard or a mouse.

The web page, a hypertext document, displayed within graphical user interface window 200 provides a patient with a number of options for creating and editing a personal medical record. The personal medical record created or accessed by the patient is stored in a medical records database, such as medical records database 102 of FIG. 6. For example, by activating button 204 with a mouse or keyboard, a patient may register his or her name in order to initiate the creation of a new medical record. By activating button 206, a patient can create or update a medical record. Alternatively, a patient can simply “click” hypertext 207 entitled “CREATE/UPDATE” and create or update a medical record. Button 208 permits a patient to print or view a copy of an existing medical record. A patient can likewise “click” hypertext 209 and print or view a copy of an existing medical record. Button 210 allows access to medical forums or chat rooms. Button 212, on the other hand, permits a patient to post messages and queries on an electronic bulletin board. Button 214 initiates the running of a medical dictionary and/or medical spell checker program. Finally, button 216 displays a web page that contains a variety of important web-based medical hypertext links that may be useful to physicians and patients. Accessing hypertext 211 also permits a patient to access the web page containing these links.

An additional graphical section 218 is displayed within graphical user interface window 200. Within graphical section 222 a “help” button is displayed which initiates the loading of a web page having information to assist a patient in using “MedicalRcords.Com”. Space can reserved within the area of any of the web pages that comprise “MedicalRecords.Com” for advertising purposes. For example, as illustrated at space 220, advertising space may be reserved for advertisements posted by potential medical device or pharmaceutical is manufacturers.

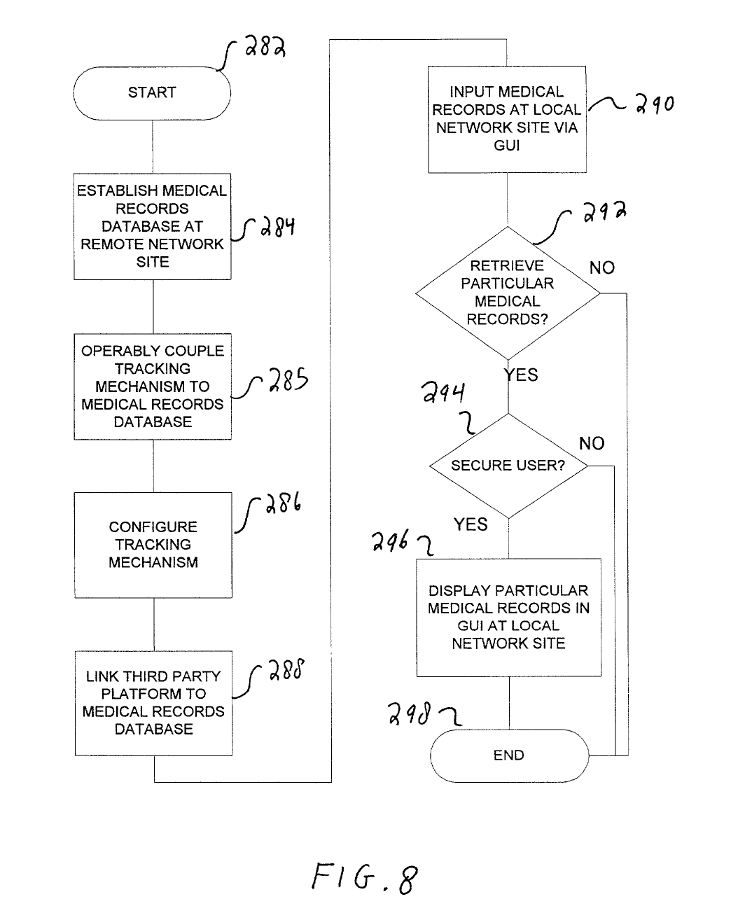

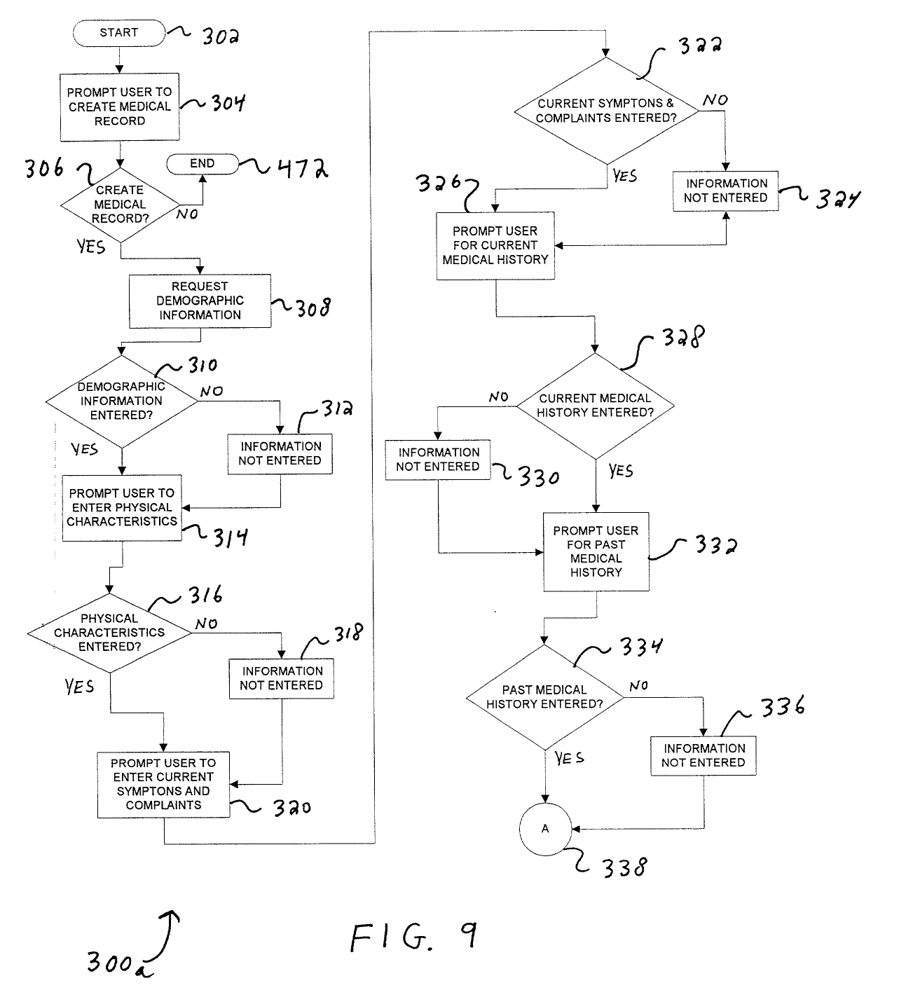

FIG. 8 illustrates a high-level logic flow diagram 280 illustrating selection steps for implementing the method and system of the present invention, in accordance with a preferred embodiment of the present invention. Additional logic flow diagrams for implementing the method and system of the present invention are also depicted in FIG. 9 to FIG. 12 herein. It can be appreciated by those skilled in the art that FIGS. 8 to 12, as illustrated and described herein, present a self-consistent sequence of steps leading to a desired result. The steps are those requiring the physical manipulation of physical quantities. Usually, although not necessarily, these quantities take the form of electrical or magnetic signals capable of being stored, transferred, combined, compared, and otherwise manipulated.

It has proven convenient at times by those skilled in the art, to refer to these signals as bits, values, elements, symbols, characters, terms, numbers, or the like. It should be borne in mind, however, that all of these and similar terms are to be associated with the appropriate physical quantities and are merely convenient labels applied to these quantities. Further, the manipulations performed are often referred to in terms, such as “configuring,” “retrieving” or “displaying”, which are commonly associated with mental operations performed by a human operator. No such capability of a human operator is necessary or desirable in most cases of the operations described herein, which form part of the present invention. As indicated herein, these operations are primarily machine operations. Useful machines for performing operations of a preferred embodiment of the present invention include data-processing systems, such as a general-purpose digital computer or other similar devices. In all cases the distinction between the method of operations in operating a computer and the method of computation itself should be borne in mind.

It can be appreciated by those skilled in the art that the method and system described herein can be implemented as a program product (e.g., a control program residing in a computer memory). The program product contains instructions that when executed on a CPU (e.g. CPU 31 of FIG. 2), carry out the operations depicted in the logic flow diagrams of FIGS. 8 to 12 presented herein. The program product may be implemented in the context of a control program, such as control program 51 of FIG. 2. For example, the control program may include specific program mechanisms, operably coupled to a medical records database electronically maintained at a remote network site within a web-based computer network. Such a control program may also be configured to further include a retrieval mechanism for retrieving particular medical records from the remote network site, in response to patient input; and a display mechanism for graphically displaying the particular medical records in a graphical user interface at the local network site, in response to retrieving the particular medical records from the remote network site, thereby enabling a patient to interactively access and review updated medical records at the local network site.

While the present invention is described in the context of a fully functional data-processing system, those skilled in the art will further appreciate that the present invention is capable of being distributed as a program product in a variety of forms. The present invention applies equally, regardless of the particular type of signal-bearing media utilized to actually carry out the distribution. Examples of signal-bearing media include recordable-type media, such as floppy disks, hard-disk drives and CD ROM's, and transmission-type media, such as digital and analog communication links.

Preferred implementations of the invention can include implementations to execute the method or methods described herein as a program product residing in a memory of microcomputer. The program product thus includes sets of instructions for executing the method and system described herein. Until required by a microcomputer, the set of instructions may be stored as a computer-program product in another computer memory. For example, the set of instructions may be stored as a computer-program product in a disk drive attached to a microcomputer (which may include a removable memory such as an optical disk or floppy disk for eventual use in the disk drive).

The computer-program product can also be stored at another computer and transmitted, when desired, to a patient's workstation by an internal or external network. Those skilled in the art will appreciate that the physical storage of the sets of instructions physically changes the medium upon which it is stored so that the medium carries computer-readable information. The change may be electrical, magnetic, chemical, or some other physical change. While it is convenient to describe the invention in terms of instructions, symbols, characters, or the like, the reader should remember that all of these and similar terms should be associated with the appropriate physical elements.

As illustrated at block 290, medical records are input at the local network site via a graphical user interface mechanism, such as graphical user interface window 200 of FIG. 7. When the records are input to the medical records database, they may be later retrieved from the medical records database, as described at block 292, wherein a test is performed to determine whether a patient desires to retrieve medical records from the medical records database. If the patient does not desire to access or retrieve medical records, then the process terminates, as indicated thereafter at block 298. However, if the patient does desire to access or retrieve particular medical records from the medical records database, then the medical records may be retrieved via a retrieval mechanism. The retrieval mechanism permits medical records to be retrieved from the remote network site, and thus from the medical records database, in response to patient input.

In order to verify that the patient is in fact a patient authorized to view medical records, a test is performed, as described at block 294, to determine if the patient is an authorized user of the system. This test can be initiated via an authorized patient password. By prompting the patient to enter an authorized patient password, a determination can be made as to whether or not the patient is a secure or authorized patient. If it is determined that the patient is not an authorized patient, then the process simply terminates, as indicated at block 298, and the patient is not allowed to view, edit or retrieve a medical record.

If it is determined that the patient is an authorized patient, then as depicted at block 298, the medical record is graphically displayed as a web page within a graphical user interface window, such as graphical user interface window 200 of FIG. 7. A display mechanism graphically displays the particular medical record in a graphical user interface (GUI) at the local network site, in response to retrieving the particular medical records from the remote network site, thereby enabling a patient to interactively access and review updated medical records at the local network site. The process thereafter terminates, as indicated at block 298.

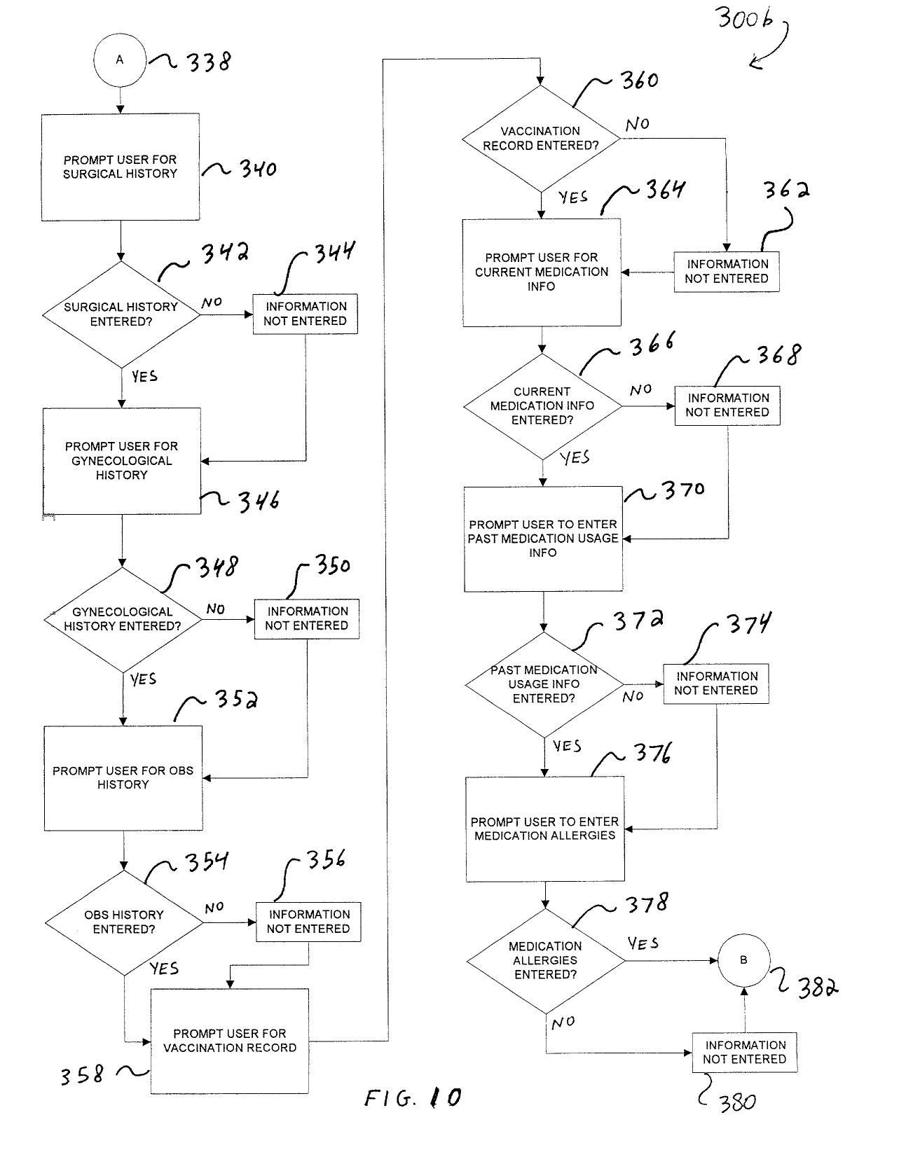

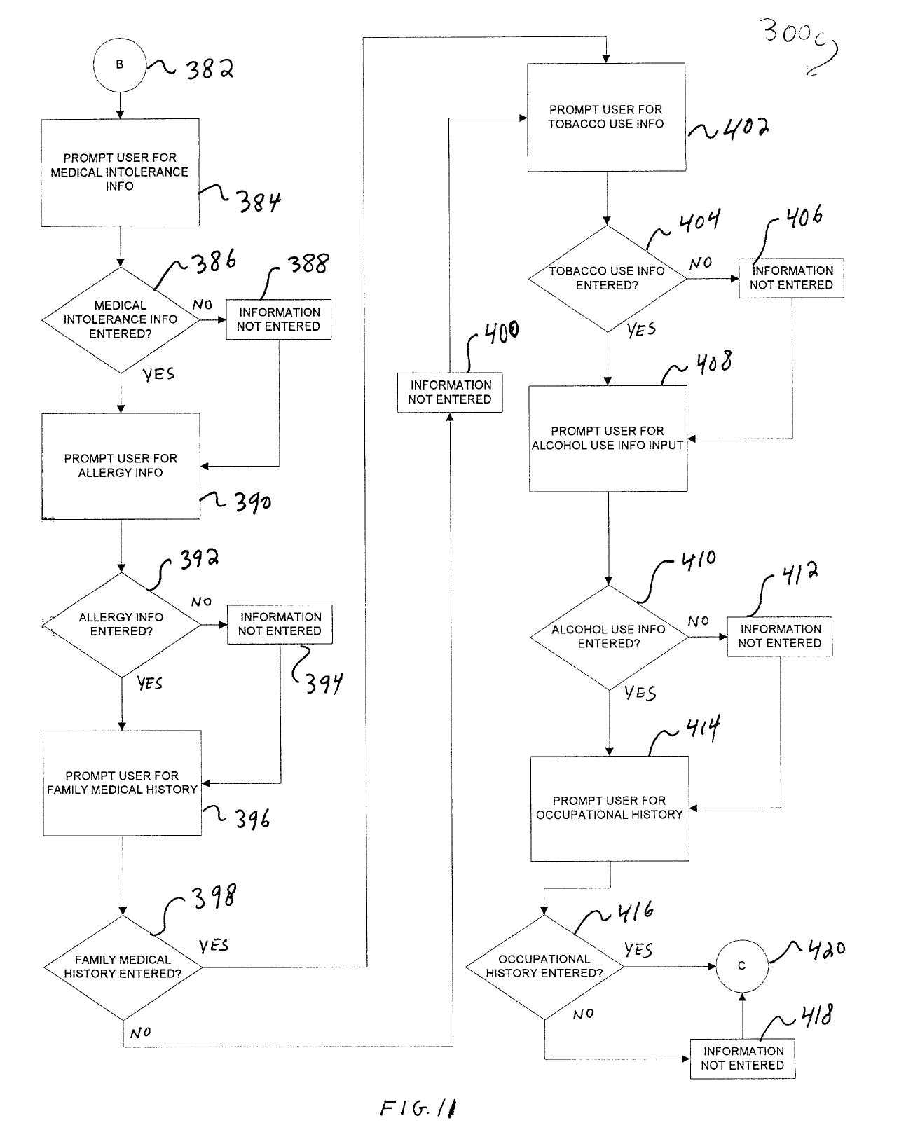

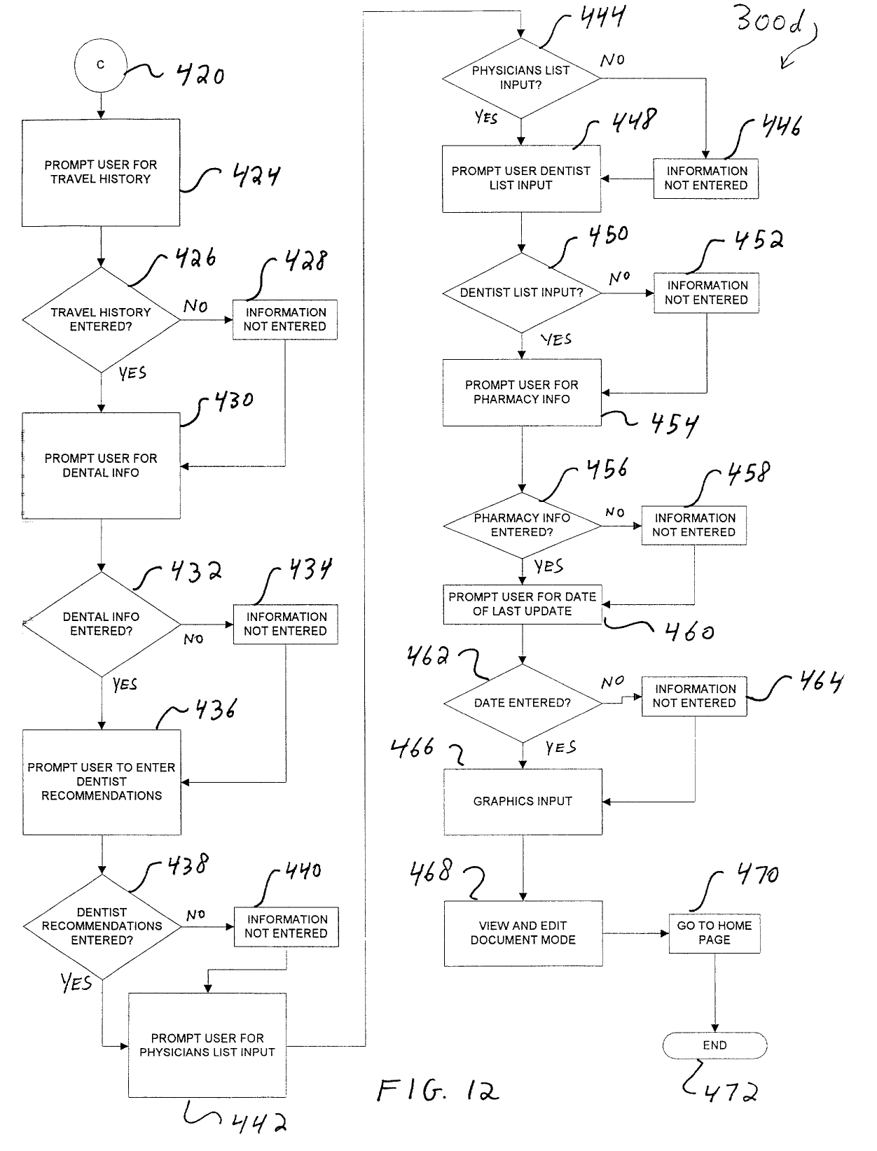

FIG. 9 illustrates a high-level logic flow diagram 300a illustrating method steps for creating an electronic web-based medical record, in accordance with a preferred embodiment of the present invention. FIG. 10 depicts additional method steps associated with the high-level flow diagram of operations illustrated in FIG. 9, in accordance with a preferred embodiment of the present invention. These additional method steps are illustrated via logic flow diagram 300b. FIG. 11 illustrates additional method steps associated with the high-level flow diagram of operations depicted in FIG. 9, in accordance with a preferred embodiment of the present invention. These additional method steps are illustrated in logic flow diagram 300c. Likewise, FIG. 12 depicts additional method steps associated with the high-level flow diagram of operations illustrated in FIG. 9, in accordance with a preferred embodiment of the present invention. These additional method steps are depicted in logic flow diagram 300d.

Thus, as illustrated at block 302 of FIG. 9, the process is initiated. As depicted thereafter at block 304, a patient is prompted to create a medical record. As indicated at block 306, a test is performed to determine whether or not the patient desires to create a medical record. If it is determined that the patient does not desire to create a medical record that will be electronically stored within a medical records database, such as medical records database 102 of FIG. 6, then the process terminates, as illustrated at block 472. However, it is determined that the patient does in fact desire to create an electronic medical record, then the patient is asked to input particular demographic information, as to depicted at block 308. As described thereafter at block 310, a test is performed to determine if demographic information is entered. The patient may in fact wish to leave this information blank. In that case, the information is not entered, and the process continues, as illustrated at block 314. However, if the information is entered, the process simply continues, as indicated at block 314, wherein a patient is prompted to input physical characteristics. As described thereafter at block 316, a test is performed to determine whether or not physical characteristics have been entered by the patient. If it is determined that physical characteristics have been entered, then the process continues, as described at block 320. However, if it is determined that physical characteristics have not been entered, then a note is made indicating that this information was not entered, as illustrated at block 318. Again, the patient may not desire to enter this information and the final medical record created as a result of processing these logical operations will not include such information.

As illustrated thereafter at block 320, a patient is prompted to enter current symptoms and complaints. As depicted next at block 322, a test is performed to determine whether or not any current symptoms and complaints have been entered. If not, then as indicated at block 324, the information is simply not entered, and a note may be made in the medical record indicating that such information has not been entered. If the current symptoms and complaints have been entered by the patient, then as described at block 326, the patient is next prompted to enter a current medical history. Again, a test is performed to determine whether or not this information was entered, as illustrated at block 328.

If it is determined that information relating the patient's current medical history has not been entered, then a note may be made in the final medical record that the information was note entered by the patient. The operation depicted at block 332 follows thereafter. Even if the current medical history was entered by the patient, the operation described at 332 is processed, wherein the patient is prompted for his or her past medical history. A test is thereafter performed, as described at block 334, which determines whether or not information relating to the patient's past medical history was entered. If the patient desires not to enter this information, then the information is simply not entered, as depicted at block 336, and the lack of such information is noted in the final compiled medical record. In either case, whether or not the information is input, the operation described at block 334 (“A”) is processed. Block 334 illustrates a connector symbol, which indicates that logical operations described herein are continued in FIG. 10.

As indicated at block 338 of logic flow diagram 300b in FIG. 10, the process continues. As illustrated thereafter at block 340, the patient is prompted to input his or her surgical history. A test is then performed, as described at block 342, to determine whether or not information relating to the patient's surgical history has been entered. If it is determined that such information has not been entered, then the medical record will reflect this lack of information, as illustrated at block 344. The operation described at block 346 is then processed accordingly. Likewise, if it is determined that information relating to the patient's surgical history has been entered, then the operation described at block 344 is processed also, wherein a patient is prompted to enter gynecological information.

A test is thereafter performed, as described at block 348, to determine if information relating to the patient's gynecological history has been entered. If it is determined that information relating to the patient's gynecological history has not been entered, then as described at block 350, the lack of this information in the medical record will be noted. In either case, whether or not the patient or patient enters such information, the patient or patient is then prompted to enter personal obstetric information, as depicted at block 352. A test is thereafter performed, as illustrated at block 354, to determine whether such obstetric information has been entered by the patient. If such information has not been entered, then a notation is made in the medical record. For example, if the patient is a male, such information will not appear in the patient's final compiled medical record. Thus, the information is simply not entered, as illustrated at block 356. In either case, whether or not such obstetric information is entered, the patient is thereafter prompted to entered information relating to the patient's vaccination record, as depicted at block 358.

A test is then performed to determine whether or not vaccination record data has been entered, as indicated at block 360. If the vaccination record is not entered, as described at block 362, then the lack of such information is noted in the final medical record. The vaccination record is simply not entered, as indicated at block 362. In either case, whether or not the vaccination record is entered by the patient, the patient is then prompted, as depicted at block 366, to input information regarding current medication utilized by the patient. If the patient determines not to enter such information, then the lack of such information is noted, as indicated at block 368.

The information is simply not entered and the lack of such information is noted in the final medical record. In either case, whether or such information is entered, the patient is then prompted, as illustrated at block 370, to enter information describing past medication usage. A test is then performed, as described at block 372, to determine whether or not such information has been entered. If such information is entered, then the patient is prompted, as indicated at block 376 to enter medications to which the patient is allergic (e.g., penicillin). Information not entered is noted, as indicated at block 374. Following processing of the operation described at block 376, a test is performed to determine whether or not such medication allergies have been entered by the patient. If so, the operations continue, as depicted at block 382 (“B”). If not, then the lack of such information is noted for the final medical record, as illustrated at block 380. The operation described at block 382 is then processed, wherein the flow diagram continues, as depicted in FIG. 11.

As indicated at block 382 of logic flow diagram 300c in FIG. 11, the process continues. As illustrated at block 384, the patient is prompted to enter information describing any personal medical intolerance of which the patient is aware. As indicated at block 386, a test is performed to determine whether or not such medical intolerance information has been entered. If it is determined that such medical intolerance information has not been input by the patient, then the lack of such information is noted for the final medical record and the operation described at block 390 is processed. If it is determined that such medical intolerance information has been entered, then as illustrated at block 390, the patient is prompted to enter allergy information. Such information relates to known patient allergies.

Thereafter, as described at block 392, a test is performed to determine if such allergy information has been entered by the patient. If not, a note is made for the final medical record. The information is simply not entered, as illustrated at block 384 and the operation described at block 396 is processed. If the allergy information is entered then the operation depicted at block 396 is directly processed, wherein the patient is prompted to enter family medical history information. The operation described at block 400 indicates that such information has not been entered and that the lack of such information is noted for the final compiled medical record.

In either case, whether or not such family medical history has been entered, the patient is then prompted as described at block 402 to enter information relating to personal tobacco use. Then, as illustrated at block 404, a test is performed to determine whether or not such information has been entered. The operation illustrated at block 406 indicates that such information has not been entered and that the lack of such information will be noted inn the final compiled medical record. In either case, whether or not such information is entered by the patient, the patient is thereafter prompted to enter information relating to personal alcohol use, as depicted at block 408.

As described next at block 410, a test is performed to determine whether or not the patient has entered information relating to the use of alcohol. The operation described at block 412 indicates that such information has not been entered and that the lack of such alcohol usage information will be noted in the final compiled medical record. In either case, whether or not such information is entered by the patient, the patient is thereafter prompted to input his or her occupational history, as described at block 414. A test is then performed to determine whether or not the patient's occupational history has been entered. The operation described at block 418 indicates that such information has not been entered by the patient, and that the lack of such information will be included in the final compiled medical record. In either case, whether or not such information is entered, the operation depicted at block 420 (“C”) is processed. Logical flow operations described according to FIG. 11 are additionally described in FIG. 12.

Thus, as illustrated at block 420 of logic flow diagram 300d in FIG. 12, the process continues. As described at block 424, the patient is prompted to enter his or her travel history. A test is then performed, as illustrated at block 426, to determine whether or not such travel history information has been entered by the patient. The operation depicted at block 428 indicates that such information was not entered and that the lack of such information will be noted in the final medical record. In either case, whether or not such information is input by the patient, the patient is then prompted, as depicted at block 420, to enter dental information. As described next at block 432, a test is performed to determine whether or not such dental information has been entered by the patient. If such information has not been entered by the patient, then a note is made for the final medical record indicative of the lack of such information, as indicated at block 434. In either case, where or not such information has been entered, the patient is thereafter prompted to enter information describing dentist recommendations. A test is then performed, as described at block 438, to determine whether or not such dentist recommendations have been entered. As indicated at block 440, a note is made for the final record that such information has not been entered. The operation described at block 442 is thereafter processed, in which a patient is prompted to enter a physicians list.

The operation described at block 442 is also processed when it is determined that the dentist recommendations have been entered. Following processing of the operation depicted at block 442, a test is performed to determine whether or not a physicians list has been entered by the patient. As illustrated at block 446, the information is not entered and the lack of such information is noted for the final medical record. The operation illustrated at block 448 is thereafter processed, in which the patient is prompted to enter a list of dentists that the patient presently utilizes or has utilized in the past. In either case, whether or not the patient enters a physicians list (i.e., a list of physicians presently or previously utilized by the patient), the operation depicted at block 448 is processed.

A test is thereafter performed, as illustrated at block 450, to determine whether or not the list of dentists has been input by the patient. Block 452 indicates that the list of dentists was not entered by the patient and that the lack of such information will be noted in the final medical record. In either case, whether or not the patient actually enters such information, the patient is then prompted, as described at block 454, to enter appropriate pharmaceutical information. Next, as indicated at block 456, a test is performed to determine whether or not such pharmacy information has been input by the patient. If such information is entered by the patient, then process described at block 460, wherein the patient is prompted to enter the date of his or her last medical update.

If the patient does not enter appropriate pharmacy information, as illustrated at block 456, then as indicated at block 458, a note will be made in the final compiled medical record attesting to the lack of such information. In any event, following processing of the operation illustrated at block 460, a test is performed, as indicated at block 462, to determine whether or not this date has been entered by the patient. If the date is not entered, then a note is made for the final record, as indicated at block 464. In either case, whether or not the date is actually entered, the web page then enters a graphics mode, as indicated at block 466, wherein the patient may graphically input additional information for the medical record. In this graphics mode, the patient may be prompted, via graphical symbols, to enter additional information which may be needed to completely compile the medical record. Then, as indicated at block 468, the patient is permitted to view and edit the medical record via a document mode. Finally, the medical record is compiled and stored at a medical records database. The patient is then returned to a “home page,” as indicated at block 470. The process then terminates, as illustrated at block 472.

Based on the foregoing it can be appreciated that a number of advantages are gained by implementing the present invention. By utilizing a web-based medical records system, as described herein, a patient can create a medical record and access the record at any local network site. For example, if a patient moves to a new city, rather than request transfer of medical records from his or her previous physician, the patient merely accesses his or her medical records electronically via the Internet. The medical records can then be printed on standardized forms at the new physician's office. In addition, a physician who has access to the patient's medical records via the “World Wide Web” can rapidly and accurately assist a patient. The medical records themselves can thus be compiled at a patient's home by the patient. The use of a tracking mechanism as described additionally permits a patient to automatically obtain accurate and up to date information regarding any pharmaceuticals or medical devices presently utilized by the patient.

Although the present invention is described herein in the context of a web-based “windows” graphical user interface environment, the present invention is not limited to a windows environment. The present invention can be practiced in any defined region of an interface having defined borders. The embodiments and examples set forth herein are presented in order to best explain the present invention and its practical application and to thereby enable those skilled in the art to make and utilize the invention.

However, those skilled in the art will recognize that the foregoing description and examples have been presented for the purpose of illustration and example only. The description as set forth is not intended to be exhaustive or to limit the invention to the precise form disclosed. Many modifications and variations are possible in light of the above teaching without departing from the spirit and scope of the following claims.

What is claimed is:

1. A medical records information system for permitting a patient to enter, alter, retrieve and store medical records data over a wide area computer network, said system comprising:
a medical records database for storing medical record information for a patient;
a client terminal at a local network site providing access to said medical records database over said computer network, said client terminal including a user interface from which the patient can enter, update and store medical records data in said medical records database; and
a security mechanism employed to provide secured access by said patient to said medical records data contained in said medical records database.

2. The medical records information system of claim 1 further comprising:
a tracking mechanism operably coupled to said medical records database electronically and maintained at a remote network site within said computer network, wherein said tracking mechanism is configured to provide a notification function for patients in said medical records database;
a retrieval mechanism for retrieving particular medical records from said remote network site, in response to patient input; and
a display mechanism for graphically displaying said particular medical records in a graphical user interface at said local network site, in response to retrieving said particular medical records from said remote network site, thereby enabling a patient to interactively access and review updated medical records at said local network site.

3. The medical records information system of claim 2 wherein said tracking mechanism further comprises a plurality of tracking directories associated to a plurality of medicines, drugs, and medical devices.

4. The medical records information system of claim 3 wherein said tracking mechanism if further adapted to register patients with said tracking directories for the receipt of notices relating to said medicines, drugs, and medical devices.

5. The medical records information system of claim 4 wherein said tracking mechanism if further adapted to permit a patient to register with particular tracking directories at his or her discretion.

6. The system of claim 5 wherein said tracking mechanism is maintained at a remote network site within said computer network and further comprising
a linking mechanism for linking a third party platform to said remote network site; and
a transmission mechanism for formatting and transmitting notices particular patients registered with said tracking directories, thereby enabling pharmaceutical and medical device manufacturers to provide said patients with current pharmaceutical and medical device information.

7. The system of claim 6 further comprising a updating mechanism for permitting said tracking mechanism to periodically update said tracking directories with current pharmaceutical and medical device information that may be of interest to patients registered with any or all of said tracking directories.

8. The system of claim 1 wherein said user interface further comprises:
a prompting mechanism for prompting a patient to enter personal medical records at said local network site; and
a transmission mechanism for transmitting said personal medical records from said local network site to said remote network site.

9. The system of claim 8 further comprising:
an analyzing mechanism for analyzing said personal medical records for possible medical anniversary data; and
a transmission mechanism for automatically transmitting medical anniversary data to patients associated with said personal medical records, in response to analyzing said personal medical records for medical anniversary data.

10. The system of claim 9 further comprising a retrieval mechanism for retrieving personal medical records from said remote network site, in response to patient input at said local network site.

11. The system of claim 10 wherein said security mechanism is configured to permit only authorized patients to retrieve personal medical records at said local network site.

12. The system of claim 1 wherein said computer network comprises a web-based computer network.

13. The system of claim 1 wherein said computer network comprises the a network supporting Transmission Control Protocol/Internet Protocol.

14. A method in a computer network for rendering medical records for patients using a client terminal and user interface at a local network site of said computer network, said method comprising the steps of:
configuring a database adapted for storing medical records in a remote network site of said computer network;
operably coupling a local network site in said computer network to said remote network site with a user interface adapted to access said database over said computer network;
configuring a security mechanism to execute a set of security measures that regulate access to the database from the local network site.

15. The method of rendering medical records for patients according to claim 14 further comprising the steps of configuring a tracking mechanism to provide notices to patients over said computer network.

16. The method of rendering medical records for patients according to claim 15 wherein said step of configuring a tracking mechanism is performed by the step of creating a set of tracking directories associated with corresponding specified medicines, drugs and medical devices.

17. The method of rendering medical records for patients according to claim 15 further comprising the step of displaying said notices to a patient user of said client terminal at said local network site.

18. The method of rendering medical records for patients according to claim 16 further comprising the steps of:
linking a third party platform to said remote network site, wherein said third party platform is associated with pharmaceutical and medical device manufacturers; and
periodically automatically transmitting particular update information to said tracking directories concerning said specified medicines, drugs and medical devices thereby providing a mechanism for patients registered with said tracking directories to received notices concerning said specified medicines, drugs and medical devices.

19. The method of rendering medical records for patients according to claim 14 further comprising the steps of:
prompting a patient to enter personal medical records at said local network site;
transmitting said personal medical records from said local network site to said remote network site when said patient has completed entering said personal medical records at said local network site;
electronically storing said personal medical records as medical records in said database at said remote network site, in response to transmitting said personal medical records from said local network site to said remote network site.

20. The method of rendering medical records for patients according to claim 19 further comprising the steps of:
analyzing said personal medical records for medical anniversary data; and
automatically transmitting medical anniversary data to patients associated with said personal medical records, in response to analyzing said personal medical records for medical anniversary data.

21. The method of rendering medical records for patients according to claim 19 further comprising the step of retrieving personal medical records from said remote network site, in response to an authorized patient input at said local network site.

22. The method of rendering medical records for patients according to claim 19 further comprising the step of permitting only authorized patients to enter personal medical records at said local network site.

23. A program product for use in client terminal at a local network site having access to a computer network, with a database adapted for storing patient medical records is located at a remote network site, said program product comprising:
an instruction mechanism for causing said client terminal to access said database over said computer network;
an instruction mechanism for causing a set of security measures to be implemented when a user of said client terminal attempts to access said database;
an instruction mechanism for retrieving patient medical records stored in said database from said remote network site, in response to patient input into said client terminal; and
an instruction mechanism for causing said client terminal to graphically display retrieved patient medical records to a patient user of said client terminal in a graphical user interface, thereby enabling a patient to access, review and update his or her medical records at stored at said remote network site from said local network site.

24. The program product of claim 23 further comprising:
an instruction mechanism for causing a tracking mechanism to maintain a patient notification function for registered patient users of said client terminal;
an instruction mechanism for causing a link to be established between a third party platform and said remote network site; and
an instruction mechanism for periodically transmitting updated information over said link to said tracking mechanism, said updated information relating to medicines, drugs or medical devices for current pharmaceutical and medical device information.

25. The program product of claim 23 further comprising an:
instruction mechanism residing in said client terminal for prompting a patient to enter personal medical records at said local network site; and
instruction mechanism residing in a computer for transmitting said personal medical records from said local network site to said remote network site when said patient has completed entering said personal medical records at said local network site;

26. The program product of claim 25 further comprising an instruction mechanism residing in a computer for electronically storing said personal medical records as medical records in said database at said remote network site, in response to transmitting said personal medical records from said local network site to said remote network site.

27. The program product of claim 26 further comprising:
instruction mechanism for analyzing said personal medical records for medical anniversary data; and
instruction mechanism for automatically transmitting medical anniversary data to patients associated with said personal medical records, in response to analyzing said personal medical records for medical anniversary data.

28. The program product of claim 24 further comprising an instruction mechanism for configuring said tracking mechanism to include a plurality of tracking directories wherein each of said tracking directories are dedicated to particular types of current medical data.
